(19) United States
(12) Patent Application Publication
(10) Pub. No.: US 2013/0293696 A1
(43) Pub. Date: Nov. 7, 2013

(54) IMAGE CONTROL SYSTEM AND METHOD THEREOF

(71) Applicants: Albert Chang, (US); Hua-Ming Chang, (US); Hwa-Ping Chang, (US)

(72) Inventors: Albert Chang, Saratoga, CA (US); Hua-Ming Chang, Taipei (TW); Wen-Lin Lin, Kee-Lung (TW); Yu-Yuan Peng, Taipei (TW); Hwa-Ping Chang, Taipei (TW)

(21) Appl. No.: 13/851,187

(22) Filed: Mar. 27, 2013

(30) Foreign Application Priority Data
Mar. 28, 2012 (TW) 101110667

(51) Int. Cl. H04N 7/18

(52) U.S. Cl. CPC H04N 7/18
USPC 348/79

(57) ABSTRACT

An image control system is provided in this application. The image control system includes an object imaging device, a control module, a viewing module and a hosting service of image sharing and management module. The present application further provides a method for image control which includes an image/audio sharing step, an image controlling step, an image/audio capturing step, an image/audio storing step, and an image analyzing and management step. Multiple users may view or control the images captured by the control module concurrently and remotely through the present application and may set different image processing modes according to the user needs.

### FIELD OF THE INVENTION

The present application relates to an image control system, specifically an image control system for users capable of viewing and operating concurrently. The present invention also relates to a method of an image control system, especially for a method of an image control system for users capable of viewing and operating concurrently.

### BACKGROUND OF THE INVENTION

Mostly, an image viewing device, such as the microscope, the telescope and so on, is operated by a single user and the image could be shared through an USB connection of a computer. But multiple remote users in the network cannot remotely control the image viewing device and cannot apply the image processing and management capabilities, such as tracking object movement path and its size change, sending out alert information to the designated users and so on. Besides, the image viewing devices are mostly limited to providing only the two-dimension images and without the capabilities to view the objects in 3-dimensional views and the rotational views. In addition, if the users are not present nearby the image viewing devices, the image data cannot be automatically recorded and collected for the later viewing and analysis. Therefore, the user cannot get notified if the monitored objects grow or move out the preset boundaries unless he stays nearby the viewing device all the time.

For instance, when an operator uses a microscope to observe the vivid samples which have the movement, deformability, development or proliferation capabilities, such as the cells and tissues, the operator has to operate the microscope for keeping sample in the restriction and stay nearby the viewing devices so as not to miss the opportunity. In addition, it is necessary, for the operator, to stay nearby the image viewing device for timely observing and then conduct the next step when the observed object has been into a specific stage, such as the observed cell has grown up to a specific number and/or size. It is still impossible to monitor and control the image viewing device remotely.

Taking the telescope as another example, when the user would like to observe an object which will move from time to time with the telescope, since the vast distance, any slight movement of telescope will result in a severe deviation of vision; therefore, it is difficult to manually adjust the telescope.

Moreover, the image viewing device is not available for multiple remote users in various locations to observe the object, send out the video information to the designated users concurrently and have some discussion therefor. It is, certainly, an inconvenience, especially while the internet, video conference and telemedicine developed are so popular currently.

As mentioned, an improved device such as an image control system and an operating method that could make it possible for operators to observe, operate, mutually communicate and manage the image concurrently are in need.

### SUMMARY OF THE INVENTION

In one aspect, an image control system is provided in this application. The image control system includes an object imaging device, a control module, a viewing module, and a hosting service of sharing and management module. The object imaging device observes an object and capturing an image/audio signal; the control module collects and transfers the image/audio signal; the viewing module provides a user interface for viewing an image of the object and controls the object imaging device; and the hosting service of sharing and management module receives the image/audio signal from the control module, distributes the image/audio signal to a user and processes the image/audio signal.

Preferably, the control module has a first network component connected with the viewing module and the hosting service of sharing and management module, a first authentication and security component storing a device credential information or a virtual private network security information, an image data processing and transfer component receiving the image/audio signal from the object imaging device and transferring it to a remote end, a device I/O control component sending out a control signal to the object imaging device, a command processing component receiving and processing a command message from the viewing module and sending it to the device I/O control component, and a moving protection component receiving a signal from the object imaging device and transferring the signal to the device I/O control component.

Preferably, the object imaging device is a microscope.

Preferably, the object imaging device includes a specimen holding platform, a lens, a position sensor, a related step motor and a photosensitive element.

Preferably, the object imaging device further includes an audio I/O component.

Preferably, the image control system controls the related step motor.

Preferably, the position sensor is connected with the lens or the specimen holding platform.

Preferably, the related step motor is connected with the lens or the specimen holding platform.

Preferably, the related step motor drives a movement or a rotation of the specimen holding platform in a three-dimensional space.

Preferably, the viewing module has a second network component connected with the control module and the hosting service of sharing and management module, a second authentication and security component collecting an authentication information, an image display component providing a viewing window to display the image of the object to the user, a device control component providing a graphical user interface for the user to control the object imaging device, a second audio I/O component distributing or receiving an audio signal, a storage component storing a static image data or a continuous movement data of the object or the audio signal, and a tracking component for the user to set up a monitoring boundary, define a threshold level of brightness or a percentage of color pixel.

Preferably, the viewing module is mounted on a personal computer or a portable electronic device.

Preferably, the hosting service of sharing and management module can run under a computer operation system or an internet environment.

Preferably, the hosting service of sharing and management module has a third network component connected with the control module and the viewing module, a third authentication and security component processing an authentication request from the control module and the viewing module, a collector and distributor component receiving the image/audio signal from the control module and distributing it to a remote user or collecting a command message from the remote user and transferring it to the control module, a user runtime policy component setting up a user-specific mode for an image data processing, a data processing component proceeding the image/audio signal according to the user-specific mode, a control component receiving a signal from the user runtime policy component and transferring it to the third network component, and an image data/audio storage component storing a static image data or a continuous movement data of the object or an audio signal.

Preferably, the user-specific mode is a monitoring of a boundary of a growing object, a path tracking of a moving object, an image brightness, a color filtering, or a three-dimensional image synthesis

Preferably, the object imaging device is a telescope.

Preferably, the control module, the viewing module, and the hosting service of sharing and management module are connected by a network.

In another aspect, a method for image control is provided. The method includes an image/audio sharing step, wherein an image/audio signal is collected by an object image device for a user to view, an image/audio controlling step, wherein the object image device is controlled by an information transfer medium, an image/audio capturing step, wherein the image/audio signal is captured, and an image/audio storing step, wherein the image/audio signal is stored.

Preferably, the object image device has a specimen holding platform or a lens, and the specimen holding platform or the lens of the object image device is controlled in the image/audio controlling step.

Preferably, the image/audio sharing step further has a step of collecting an audio signal for the user to listen the image/audio capturing step further has a step of receiving the audio signal, and the image/audio storing step further has a step of storing the audio signal.

Preferably, the image/audio storing step is to store the image/audio signal into a user's storage device or an internet storage space.

Preferably, the method for image control further has an image/audio analyzing and management step, wherein the image/audio signal is analyzed and an image/audio processing is set up.

Preferably, the image/audio analyzing and management step is a step of tracking and recording an object movement path.

Preferably, the image/audio analyzing and management step is a step of monitoring an object beyond a preset boundary or not.

Preferably, the image/audio analyzing and management step is a step of determining a brightness of an image or a percentage of a color pixel.

Preferably, the image/audio analyzing and management step is a step of synthesizing a three-dimensional image or a continuous video.

Preferably, the method for image control further has a step of providing an alert to the user when a criterion of the image/audio analyzing and management step is satisfied.

The spirit of the invention will be more readily appreciated by one of ordinary skilled in the art from the following drawings, working examples and descriptions.

### BRIEF DESCRIPTION OF THE DRAWINGS

FIG. 1 is a block diagram of the image control system for one embodiment of the present application.

FIG. 2 is a block diagram of an image control system for a preferred embodiment of the present application.

FIG. 3 is a block diagram of a control module for a preferred embodiment of the present application.

FIG. 4 is a block diagram of a viewing module for a preferred embodiment of the application.

FIG. 5 is a block diagram of a hosting service of sharing and management module for a preferred embodiment of the present application.

FIG. 6 is a block diagram of a hardware mechanism design for a preferred embodiment of the present application.

FIG. 7 is a process flow diagram of a method for image control in an embodiment of the present application.

FIG. 8 is another process flow diagram of a method for image control in an embodiment of the present application.

### DETAILED DESCRIPTION OF THE INVENTION

The spirit of this application will be readily appreciated and practiced by one of ordinary skilled in the art from the following drawings, working examples, embodiments, and descriptions. The well-known circuits, structures and techniques have not been shown in detail so as to unnecessary misleading of the descriptions. The practicing of the application is not limited by the following embodiments.

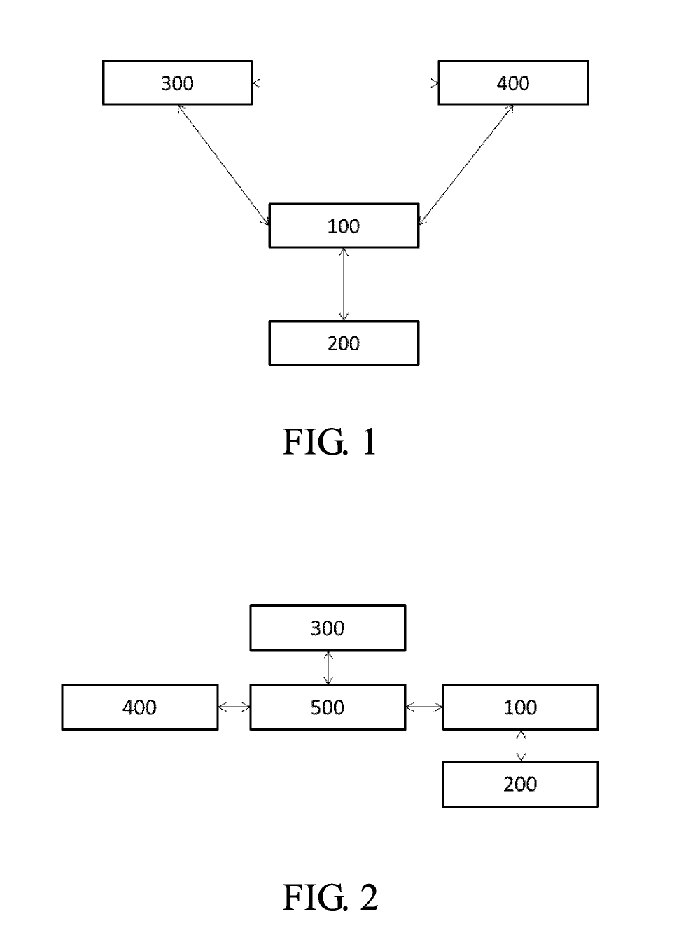

FIG. 1 is a block diagram of the image control system for one embodiment of the present application. In FIG. 1, a control module 100, an object imaging device 200, a viewing module 300 and a hosting service of sharing and management module 400 are disclosed. The control module 100 collects the image/audio signal and transfers the signal to the hosting service of sharing and management module 400; the viewing module 300 provides an user interface for the operator to view the object images and to control the object imaging device 200; the hosting service of sharing and management module 400 receives the image/audio signal from the control module 100, distributes the image/audio signal to the viewing module 300 and processes the image/audio signal for the future path tracking of moving objects, image boundary triggering, image color and brightness filtering, and image data synthesis.

FIG. 2 is a block diagram of an image control system for a preferred embodiment of the present application. In this embodiment, the control module 100, the viewing module 300 and the hosting service of sharing and management module 400 are connected with a network 500. The network 500 provides an interconnection among multiple electronic devices and a communication with the remote device(s) which are not shown in FIG. 2. In another preferred embodiment, the network 500 is the Internet and the control module 100 is connected with the object imaging device 200 by a wired link. The details of the major functional modules above-mentioned are described as following.

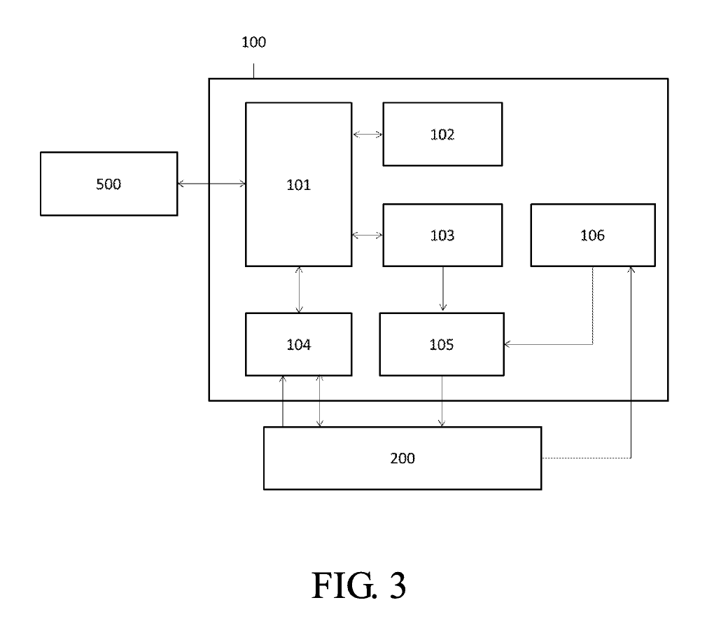

FIG. 3 is a block diagram of a control module for a preferred embodiment of the present application. In this embodiment, the control module 100 is an embedded device of the real-time operating system. The control module 100 has a first network component 101; a first authentication and security component 102; a remote command processing component 103; an image data processing and transfer component 104; a device I/O control component 105; and a moving protection component 106.

The first network component 101 is the connection interface for the control module 100 and the network 500, and it could be a wireless or wired connection. The network component 101 has PHY and MAC layers, and they could be IEEE 802.11 Ethernet, IEEE 802.15.4, IEEE 802.3, IEEE 802.15.1 or other wired or wireless network protocols. The upper layers could be based on TCP/IP connection to provide session-based network connections. If the image data is sensitive or confidential, a Secure Socket Layer, SSL, with pre-authorized certificate could be an implementation. Virtual private network (VPN) could be another implementation depending on the level of security requirements and cost of implementation. Due to the high volume of data, some known compression techniques could also be applied.

The first authentication and security component 102 is the repository of the device credential, such as username and password combination, or device certificate of authentication. It could be the place to store VPN security information.

The image data processing and transfer component 104 receives the raw digitized data from the object imaging device 200 and processes them into JPEG or MPEG data stream or the other file formats. And the data streams or other file formats could be transferred to the hosting service of sharing and management module (not shown in FIG. 3) by the network 500 for future data distribution. Moreover, the image data processing and transfer component 104 can receive an audio signal from the object imaging device 200 and then transfer it to the remote user viewing module(s) (not shown in FIG. 3) by the network 500 for playing or storage; and it also can transfer the audio signal from the remote users to the object imaging device 200 for playing.

When the remote user gives an command to control the object image device 200, the command will be interpreted and translated into a machine code by the remote command processing component 103 and then be sent to the device I/O control component 105 for the actual execution on the related step motor of the object imaging device 200.

The moving protection component 106 is a hardware mechanism for protecting the object imaging device 200. The object imaging device 200 has a position sensor thereon, and it could send the position signal back to the moving protection component 106 for further controlling the operation of the related step motor from the device I/O control component 105 in order to prevent the hardware mechanism from exceeding the movement boundary.

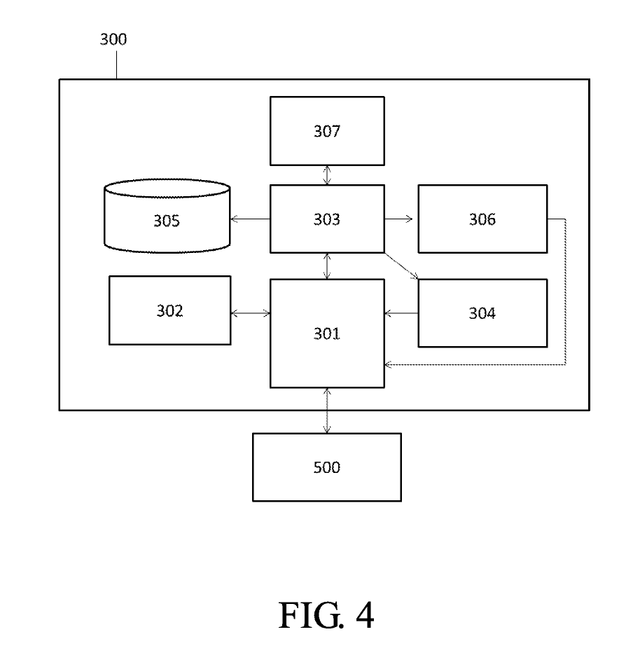

FIG. 4 is a block diagram of a remote user viewing module for the preferred embodiment of the application. Users will use the remote user viewing module 300 to view the object images. The remote user viewing module 300 could be run by the application software or stand-alone software on the browser of computers, smart phones, or other mobile devices. As shown in FIG. 4, the remote user viewing module 300 has a second network component 301, a second authentication and security component 302, a remote image display component 303, a first remote device control component 304, a local image data/audio storage component 305, a remote image data tracking component 306, and a second audio I/O component 307.

The second network component 301 is a connection interface for the remote user viewing module 300 and the network 500 and it could be a wireless or wired connection. Relevant descriptions please refer to the first network component 101.

The second authentication and security component 302 will collect the authentication information either from a graphical user interface, GUI, or a preset authentication certificate. If a SSL connection is required for security reason, a certificate might be needed for the data encryption.

The remote image display component 303 will provide the viewing window to display the object image to the users. With the remote image display component 303, remote users may view the images concurrently during the reaction time of the Internet.

Regarding FIG. 2 and FIG. 4, the first remote device control component 304 will provide the GUI for users to control the object imaging device 200 of FIG. 2. The control functions could be the incremental movement of a specimen holding platform (not shown) along the X, Y, or Z axis, or the angular incremental movement of the specimen holding platform along the X, Y, or Z axis or the focal length of the lens (not shown) on the object imaging device 200.

The user could use the local image data/audio storage component 305 to save the static object image into the JPEG file or the continuous object movement into the MPEG video file or other file formats. And the user could display, and download the static object image or continuous object movement file in the Internet. In the meanwhile, the local image data/audio storage component 305 can record the audio communication among remote users. The data files above-mentioned could be stored at the local computer or a hosting service of sharing and management module (not shown).

The remote image data tracking component 306 allows the user to set up at least one of the monitoring boundary of the viewed objects or define the threshold level of brightness or percentage of color pixels. Once the viewed object moves beyond the preset boundaries or the threshold is met, an alert will be triggered and the control system will send out the alert to the user.

The users could communicate with each other by the remote user viewing module 300 with the second audio I/O component 307. With the second audio I/O component 307, remote users could communicate with each other and the audio message of the relevant discussions could be distributed and listened concurrently during the reaction time of the Internet. The audio message could be saved in the local image data/audio storage component 305 or a remote image data/audio storage component 407 (not shown in FIG. 4). In one of embodiment, the second audio I/O component 307 could be a microphone or/and a megaphone.

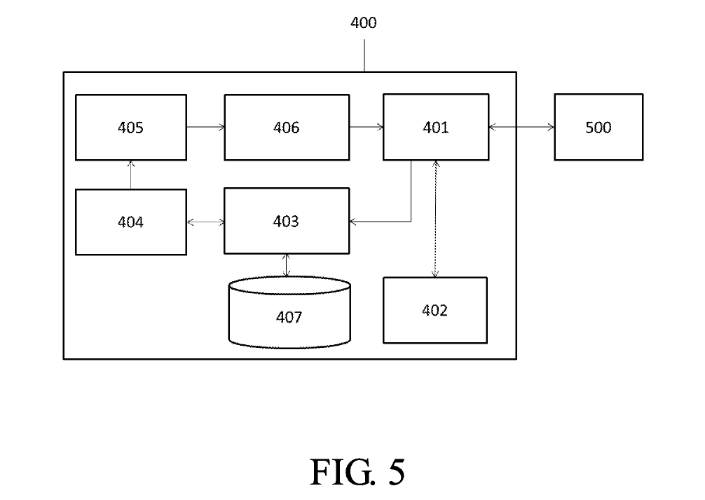

FIG. 5 is a block diagram of a hosting service of sharing and management module for a preferred embodiment of the present application. The hosting service of sharing and management module 400 can be run under the typical computer operating systems, such as Microsoft Windows Server or Linux distributions in the internet cloud environment. The hosting service of sharing and management module 400 includes a third network component 401 a third authentication and security component 402, an image data/audio collector & distributor component 403, an image data processing component 404, an user runtime policy component 405, a second remote device control component 406 and a remote image data/audio storage component 407.

The third network component 401 is a connection interface for the hosting service of sharing and management module 400 and the network 500 and it could be a wireless or wired connection. For the relevant description, please refer to the first network component 101.

The third authentication and security component 402 is used to process the authentication requests sent from the control module 100 (not shown in FIG. 5) or the remote user viewing module 300 (not shown in FIG. 5). Either a username/password combination or a certificate-based authentication is applied, the third authentication and security component 402 will verify the username and password credential or certificate with databases. If the SSL data encryption is applied, the third authentication and security component 402 will decrypt the data for further processing.

The image data/audio collector & distributor component 403 could receive the image/audio signal from one or multiple control module 100 as shown in FIG. 1, maintain the image/audio signal into different channels for forming continuous data streams, and then distribute the signal to the remote users for viewing. The image data/audio collector & distributor component 403 also collects the operating commands from remote users and transfers to the target, the control module 100 as shown in FIG. 1. Therefore, the users can remotely operate the object imaging device 200 in FIG. 1. Moreover, the image data/audio collector & distributor component 403 also can store the image/audio signal in the remote image data/audio storage component 407 for further processing. With the remote image data/audio storage component 407, users could save the static object image into JPEG files or the continuous object movement into MPEG video files or the other file formats, and the user also could display and download the static object image or the continuous object movement file in the Internet. In the meanwhile, the remote image data/audio storage component 407 can record the audio communication among remote users.

The image data processing component 404 proceeds the collected image/audio signal according to the image data process of the user runtime policy component 405, such as the functions of monitoring boundaries of the viewing objects, tracking the path of moving objects, filtering image brightness or colors, and synthesizing the three-dimensional image from at least one image signal and so on.

The user runtime policy component 405 will set up the image data processing modes based on the user-specific policies. The policies could be the preset monitoring boundaries, the threshold level of brightness or color filtering and so on. When a trigger criterion is satisfied, the alert will be sent from the second remote device control component 406 to users who want to be notified or other preset action will be proceeded. After the mentioned the image data processing modes are set up, it will automatically proceed the corresponding the image signal collecting and analysis, and it is not necessary for the user to sign in the relevant image control system.

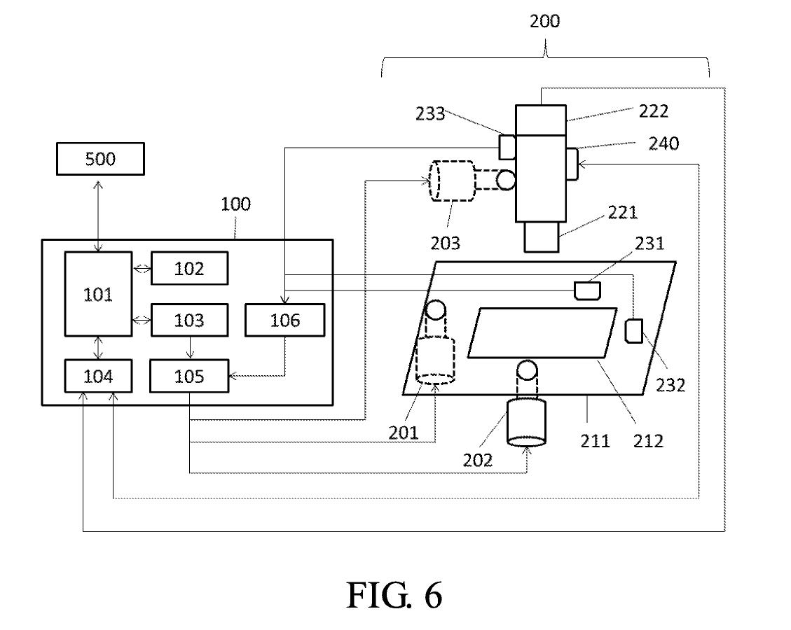

FIG. 6 is a block diagram of a hardware mechanism design for a preferred embodiment of the present application. The object imaging device 200 has a specimen holding platform 211; a lens 221; and a photosensitive element 222. The photosensitive element 222 is preferably be a charge coupled device, CCD, or a complementary metal-oxide-semiconductor, CMOS. The specimen holding platform 211 is used for placing a sample to be observed and includes a slide 212 which could carry the sample thereon. The lens 221 is preferably an objective lens or optical zoom lens. The photosensitive element 222 is used to sense the light and transfer the image into digital signal for further transmission to the image data processing and transfer component 104. The first related step motor 201 is connected to the specimen holding platform 211 and can adjust the X axis movement; the second related step motor 202 is connected to the specimen holding platform 211 and can adjust the Y axis movement; and the third related step motor 203 is connected to the lens 221 and can adjust the focuses of lens (which is equivalent to adjust the sample relative position of the Z axis on the specimen holding platform 211).

When the remote user gives a command to control the object imaging device 200, the command will be interpreted and translated into machine codes by the remote command processing component 103 and then be sent to the device I/O control component 105 for the actual executions on the first related step motor 201, the second related step motor 202 and the third related step motor 203 of the object image device 200, in order to drive the specimen holding platform 211 to have a corresponding movement or rotation on the X, Y, or Z axis; and/or to adjust the focuses of lens. In addition, in order to observe the three-dimensional object image, the plurality of photosensitive elements 222 could be mounted in different angular positions of the object imaging device 200 so as to collect images of objects.

Moreover, the object imaging device 200 includes a first position sensor 231, a second position sensor 232, and a third position sensor 233. The first position sensor 231 and second position sensor 232 are used in detecting the position of the specimen holding platform 211 on X and Y axes, and the third position sensor 233 is used in detecting the position of the lens 221. When above-mentioned position sensors 231, 232 and 233 detects the movement of the specimen holding platform 211 or the lens 221 beyond the set movement boundary, a signal will be sent back to the moving protection component 106 of the image control module 100 and then further fed back to the device I/O control component 105, so as to make sure that the lens 221 or the specimen holding device 211 will still move in the appropriate boundary.

In FIG. 6, the object imaging device 200 further includes a first audio I/O component 240 for distributing or receiving an audio signal. The audio signal received by the first audio I/O component 240 could be sent a remote end through the image data processing and transfer component 104. And, similarly, the remote user can send an audio signal through the image data processing and transfer component 104 to the first audio I/O component 240 for distributing, so that the remote user can communicate with the user who operating the object imaging device 200 and the audio messages during the communication could be stored in a local image data/audio storage component (not shown in FIG. 6) or a remote image data/audio storage component (not shown in FIG. 6). In one embodiment, the first audio I/O component 240 could be a microphone or/and an amplifier.

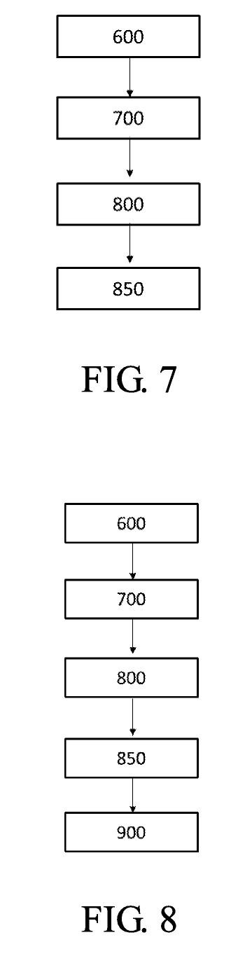

FIG. 7 is a process flow diagram of a method for image control in an embodiment of the present application. The method for image control includes an image/audio sharing step 600, an image/audio controlling step 700, an image/audio capturing step 800 and an image/audio storing step 850. In the image/audio sharing step 600, an image signal is received by an object imaging device for a user to observe. After the observation, if necessary, the user can proceed the image/audio controlling step 700, i.e. the user could control the object imaging device by a information transfer medium; and the user also could proceed the image/audio capturing step 800 to the image signal so as to capture the image signal. And, in the image/audio storing step 850, the image signal is stored as a static object image with JPEG files or as a continuous object movement with MPEG files or the other file formats. The above mentioned files could be stored in the user's storage device or an internet storage space. Furthermore, an audio signal could also be collected by the image/audio sharing step 600 for the user to listen. The audio signal could be captured by the image/audio capturing step 800 and it could also be stored in the image/audio storing step 850.

FIG. 8 is another process flow diagram of a method for image control in an embodiment of the present application. In this embodiment, the method of image control further includes an image analyzing and management step 900. Users can keep the user-specific policies for the image data processing, with the image analyzing and management step 900. The policies could include the tracking and recording of the object movement path, the monitoring of whether the object beyond the preset boundaries or not, the detecting of the threshold level of brightness or color filtering, the synthesizing of the three-dimensional image or continuous video, etc. Moreover, when a trigger criterion of the image analyzing and management step 900 is satisfied, the alert would be sent to the remote end by e-mail, short-message or real-time message or other present action will be started. When the mentioned image data processing is set up, the collection and analysis for the corresponding image signal will be automatically proceeded.

If refer to the image control system in FIG. 1, the image/audio sharing step 600 of the method of the image control is processed by the control module 100, the object imaging device 200 and the remote user viewing module 300; the image/audio controlling step 700 is processed by the control module 100, the object imaging device 200, the remote user viewing module 300, the hosting service of sharing and management module 400; the image/audio capturing step 800 is processed by the image data/audio collector & distributor component 403 of the hosting service of sharing and management module 400; and the image/audio storing step 850 is processed by the local image data/audio storage component 305 of the viewing module 300 or the remote image data/audio storage component 407 of the hosting service of sharing and management module 400; and the image analyzing and management step 900 is processed by the image data processing component 404, the user runtime policy component 405 and the second remote device control component 406 of the hosting service of sharing and management module 400.

The foregoing descriptions are mere preferred embodiments of the application which are not meant to limit the scope of the present application. Any variations and modifications without departing from the spirit and scope of the present application made by any skilled in the art are all encompassed in the appended claims.

1. An image control system, comprising:
an object imaging device observing an object and capturing an image/audio signal;
a control module collecting and transferring the image/audio signal;
a viewing module providing a user interface for viewing an image of the object and controlling the object imaging device; and
a hosting service of sharing and management module receiving the image/audio signal from the control module, distributing the image/audio signal to a user and processing the image/audio signal.

2. The image control system as claimed in claim 1, wherein the control module comprises:
a first network component connected with the viewing module and the hosting service of sharing and management module;
a first authentication and security component storing a device credential information or a virtual private network security information;
an image data processing and transfer component receiving the image/audio signal from the object imaging device and transferring it to a remote end;
a device I/O control component sending out a control signal to the object imaging device;
a command processing component receiving and processing a command message from the viewing module and sending it to the device I/O control component; and
a moving protection component receiving a signal from the object imaging device and transferring the signal to the device I/O control component.

3. The image control system as claimed in claim 1, wherein the object imaging device is a microscope.

4. The image control system as claimed in claim 1, wherein the object imaging device comprises:
a specimen holding platform, a lens, a position sensor, a related step motor and a photosensitive element.

5. The image control system as claimed in claim 4, wherein the object imaging device further comprises an audio I/O component.

6. The image control system as claimed in claim 4, wherein the image control system controls the related step motor.

7. The image control system as claimed in claim 4, wherein the position sensor is connected with the lens or the specimen holding platform.

8. The image control system as claimed in claim 4, wherein the related step motor is connected with the lens or the specimen holding platform.

9. The image control system as claimed in claim 8, wherein the related step motor drives a movement or a rotation of the specimen holding platform in a three-dimensional space.

10. The image control system as claimed in claim 1, wherein the viewing module comprises:
a second network component connected with the control module and the hosting service of sharing and management module;
a second authentication and security component collecting an authentication information;
an image display component providing a viewing window to display the image of the object to the user;
a device control component providing a graphical user interface for the user to control the object imaging device;
a second audio I/O component distributing or receiving an audio signal;
a storage component storing a static image data or a continuous movement data of the object or the audio signal; and
a tracking component for the user to set up a monitoring boundary, define a threshold level of brightness or a percentage of color pixel.

11. The image control system as claimed claim 1, wherein the viewing module is mounted on a personal computer or a portable electronic device

12. The image control system as claimed in claim 1, wherein the hosting service of sharing and management module can run under a computer operation system or an internet environment.

13. The image control system as claimed claim 1, wherein the hosting service of sharing and management module comprises:
a third network component connected with the control module and the viewing module;
a third authentication and security component processing an authentication request from the control module and the viewing module;
a collector and distributor component receiving the image/audio signal from the control module and distributing it to a remote user or collecting a command message from the remote user and transferring it to the control module;
a user runtime policy component setting up a user-specific mode for an image data processing;
a data processing component proceeding the image/audio signal according to the user-specific mode;
a control component receiving a signal from the user runtime policy component and transferring it to the third network component; and
an image data/audio storage component storing a static image data or a continuous movement data of the object or an audio signal.

14. The image control system as claimed in claim 13, wherein the user-specific mode is a monitoring of a boundary of a growing object, a path tracking of a moving object, an image brightness, a color filtering, or a three-dimensional image synthesis

15. The image control system as claimed in claim 1, wherein the object imaging device is a telescope.

16. The image control system as claimed in claim 1, wherein the control module, the viewing module, and the hosting service of sharing and management module are connected by a network.

17. A method for image control in an image control system, comprising:
an image/audio sharing step, wherein an image/audio signal is collected by an object image device for a user to view and control;
an image/audio controlling step, wherein the object image device is controlled by an information transfer medium;
an image/audio capturing step, wherein the image/audio signal is captured; and
an image/audio storing step, wherein the image/audio signal is stored.

18. The method of image control system as claimed in claim 17, wherein the object image device comprises a specimen holding platform or a lens, and the specimen holding platform or the lens of the object image device is controlled in the image/audio controlling step.

19. The method of image control system as claimed in claim 17, wherein the image/audio sharing step further comprises a step of collecting an audio signal for the user to listen; the image/audio capturing step further comprises a step of receiving the audio signal; and the image/audio storing step further comprises a step of storing the audio signal.

20. The method of image control system as claimed in claim 19, wherein the image/audio storing step is to store the image/audio signal into a user's storage device or an internet storage space.

21. The method of image control system as claimed in claim 17 further comprising an image/audio analyzing and management step, wherein the image/audio signal is analyzed and an image/audio processing is set up.

22. The method of image control system as claimed in claim 21, wherein the image/audio analyzing and management step is a step of tracking and recording an object movement path.

23. The method of image control system as claimed in claim 21, wherein the image/audio analyzing and management step is a step of monitoring an object beyond a preset boundary or not.

24. The method of image control system as claimed in claim 21, wherein the image/audio analyzing and management step is a step of determining a brightness of an image or a percentage of a color pixel.

25. The method of image control system as claimed in claim 21, wherein the image/audio analyzing and management step is a step of synthesizing a three-dimensional image or a continuous video.

26. The method of image control system as claimed in claim 21 further comprising a step of providing an alert to the user when a criterion of the image/audio analyzing and management step is satisfied.
